(19) United States
(12) Patent Application Publication
(10) Pub. No.: US 2025/0360579 A1
(43) Pub. Date: Nov. 27, 2025

(54) SYSTEM FOR AND METHOD OF MANUFACTURING A WORKPIECE USING MULTIPLE TYPES OF LASERS AND POWER LEVELS

(71) Applicant: Manaflex, LLC, Waikoloa, HI (US)

(72) Inventors: Robert C. LANE, Las Vegas, NV (US); Augusto E. BARTON, Pinecrest, FL (US); Yifei LIU, Toronto (CA)

(21) Appl. No.: 19/213,161

(22) Filed: May 20, 2025

Related U.S. Application Data
(60) Provisional application No. 63/650,994, filed on May 23, 2024.

(51) Int. Cl. B23K 26/382; B23K 26/06; B23K 26/70

(52) U.S. Cl. CPC B23K 26/382; B23K 26/0604; B23K 26/70

(57) ABSTRACT

Utilizing multiple cutting devices in series in a patterning process of a workpiece. In one implementation, multiple sets of cutting devices can be used in series. The cutting devices may be lasers, and each of the sets of lasers may operate at different power levels. In one embodiment, high power lasers are used initially for an initial coarse ablation of a workpiece. The workpiece is then processed by lower power lasers for fine ablation. The cutting lasers can be arranged at any point in the process. In one implementation, a slug removal process is included at the end of the processes if laser cutting is involved.

### CROSS-REFERENCE TO RELATED APPLICATION

This application is a non-provisional application of, and claims priority to and the benefit of, U.S. Provisional Patent App. No. 63/650,994, entitled “SYSTEM FOR AND METHOD OF MANUFACTURING A WORKPIECE USING MULTIPLE TYPES OF LASERS AND POWER LEVELS”, filed May 23, 2024, with Attorney Docket No. 4375.0008P, the entire disclosure of which is incorporated by reference herein in its entirety.

### FIELD OF INVENTION

The present invention relates to a process and a system for manufacturing a workpiece, and more particularly, to a system for and a method of manufacturing a workpiece using multiple types of lasers and power levels.

### BACKGROUND

Existing manufacturing processes usually require a desired pattern for a workpiece to be optimized for a single specific laser process only. For example, a desired pattern may include narrow features or pieces of material to be removed from the workpiece. Alternatively, a desired pattern may include wider patterns with larger slugs to be removed from the workpiece. While cutting with a laser does not work well for narrow features in a workpiece, such cutting is better suited for well-spaced patterns with large slugs. Similarly, laser ablation is not an optimal process for the removal of material in patterns with large slugs, but is better suited for narrow features and small slugs.

As a result, existing manufacturing processes are limited in accomplishing different patterns in a single workpiece, and create a limitation in the geometries of patterns in a workpiece.

Thus, there is a need for a system for and a manufacturing process of a workpiece that enables a variety of patterns to be formed in a workpiece.

### SUMMARY

In one aspect of the invention, a system for processing a workpiece comprises a laminating station at which a first material is laminated to a second material, a laser cutting device, a high power ablation device, and a low power ablation device, wherein the workpiece can be processed by one or more of the laser cutting device, the high power ablation device, or the lower power ablation device to remove a slug from the workpiece.

In one embodiment, the slug is a first slug, the first slug is removed from the workpiece using the laser cutting device, and a second slug is removed from the workpiece by the high power ablation device.

In another embodiment, the first slug has a first width, the second slug has second width, and the second width is smaller than the first width.

In yet another embodiment, the first slug has a variable width.

In one aspect of the present disclosure, a process for manufacturing a workpiece comprises the steps of laminating a first material to a second material to form a workpiece, laser cutting part of the workpiece to remove a first portion of the workpiece, and ablating part of the workpiece to remove a second portion of the workpiece.

In one embodiment, the step of ablating part of the workpiece includes using a coarse ablating process that is a blind cut and depth controlled.

In another embodiment, the step of ablating part of the workpiece includes using a fine ablating process.

In an alternative embodiment, the fine ablating process is a through cut.

In another embodiment, the process further comprises the step of ablating part of the workpiece to remove a third portion of the workpiece at a second power level, wherein the step of ablating part of the workpiece to remove a second portion of the workpiece is at a first power level that is higher than the second power level.

In another aspect of the present disclosure, a process for manufacturing a workpiece comprises the steps of laminating a first material to a second material to form a workpiece, laser cutting a first part of the workpiece to remove a first portion of the workpiece from between a first section of the workpiece and a second section of the workpiece, and ablating a second part of the workpiece to remove a second portion of the workpiece from between the first section of the workpiece and the second section of the workpiece, wherein the laser cutting is at a first power level and the ablating is at a second power level, and the second power lever is different from the first power level.

In one embodiment, the step of ablating part of the workpiece includes using a coarse ablating process that is a blind cut and depth controlled.

In another embodiment, the step of ablating part of the workpiece includes using a fine ablating process.

In an alternative embodiment, the fine ablating process is a through cut.

In yet another embodiment, the process further comprises the step of ablating a third part of the workpiece to remove a third portion of the workpiece from between the first section of the workpiece and the second section of the workpiece, wherein the step of ablating a third part of the workpiece is at a third power level that is different from the first power level and the second power level.

### BRIEF DESCRIPTION OF THE DRAWINGS

To complete the description and in order to provide for a better understanding of the present application, a set of drawings is provided. The drawings form an integral part of the description and illustrate embodiments of the present application, which should not be interpreted as restricting the scope of the invention, but just as examples. The drawings comprise the following figures:

FIG. 1 illustrates a schematic drawing of an embodiment of a manufacturing system according to an aspect of the present disclosure.

FIG. 2 illustrates an exemplary process on a workpiece according to the present disclosure.

FIG. 3 illustrates another exemplary process on a workpiece according to the present disclosure.

FIG. 4 illustrates another exemplary process on a workpiece according to the present disclosure.

FIG. 5 illustrates another exemplary process on a workpiece according to the present disclosure.

FIG. 6 illustrates a plan view of a workpiece with different patterns of material to be removed therefrom according to the present disclosure.

FIG. 7 illustrates a side view of a conventional workpiece that was formed using a conventional process.

FIG. 8 illustrates a side view of a workpiece that was formed using one of the processes described in the present disclosure.

Like reference numerals have been used to identify like elements throughout this disclosure.

### DETAILED DESCRIPTION

The following description is not to be taken in a limiting sense but is given solely for the purpose of describing the broad principles of the invention. Embodiments of the invention will be described by way of example, with reference to the above-mentioned drawings showing elements and results according to the present invention.

The present disclosure relates to the concept of utilizing multiple cutting devices in series in a patterning process of a workpiece. In one implementation, multiple sets of cutting devices can be used in series. The cutting devices may be lasers, and each of the sets of lasers may operate at different power levels.

In one embodiment, high power lasers are used initially for an initial coarse ablation of a workpiece. The workpiece is then processed by lower power lasers for fine ablation. The cutting lasers can be arranged at any point in the process. In one implementation, a slug removal process is included at the end of the processes if laser cutting is involved.

The aspects described herein relate to a laser process for the patterning of a single layer. The process involves multiple different sub-processes that use of different types of lasers to form the variety of features to be applied to a single layer.

For patterns that have features and slugs wider than 0.5 mm (this dimension can scale up with material thickness), a laser can be used to cut through the full thickness of the layer with a slug removal process that resembles an adhere-and-peel action. This process works ideally for patterns with large and continuous slug. Narrow features can easily be damaged, and/or narrow or isolated slugs that are difficult to peel off.

Features that require fine control over the depth of the laser ablation, either to prevent laser damage to bottom cover-layer or to achieve a pre-determined depth, can be achieved using the processes described herein. In one embodiment, a process uses a combination of a high power laser as the first pass, and low power lasers (such as a UV laser) for any following refinement passes. The result of the processes is a single layer with all of the above features at random area of the work piece. The processes described herein unlock the limitation to the pattern's variety. A single pattern can have all the benefits from the features and processes described herein.

The processes described herein result in a more flexible pattern designs on a workpiece. In some implementations, pattern features from multiple laser processes can be combined on a single layer. As a result, the process footprint required is reduced. Also, multiple laser processes can be accomplished in a one-stop solution.

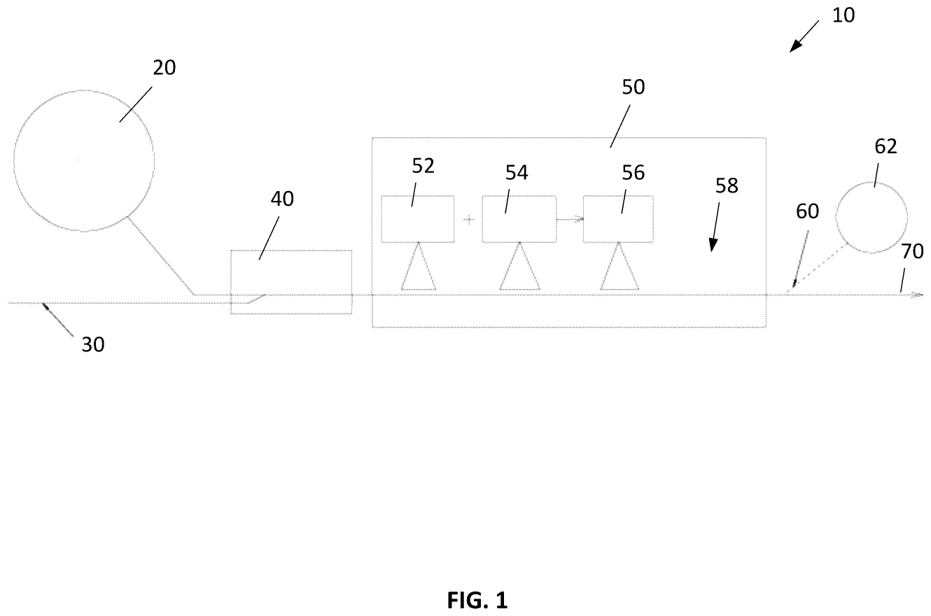

Turning to FIG. 1, an embodiment of a system according to the present invention is illustrated. In this embodiment, the system 10 includes a raw material reel 20 that supplies a raw material to the process, and one or more other layers 30 of material that are also supplied to the process. The raw materials are directed and fed to a lamination station 40 at which a lamination process occurs. At lamination station 40, the raw materials are laminated together.

The system 10 includes a laser cutting/ablation station 50 at which multiple laser cutting/ablation processes are applied to the laminated workpieces. In this embodiment, the laser cutting/ablation station 50 includes multiple laser devices. In particular, a first laser or cutting device 52 is used to perform a cutting process on the workpiece. Next, a second laser or cutting device 54 performs ablation at a high power level on the workpiece. Then, a third laser or cutting device 56 performs ablation at a lower power level on the workpiece. In some embodiments, one or more additional cutting or ablation processes 58 can be performed on the workpiece at the laser cutting/ablation station 50.

In this embodiment, the system 10 includes a slug removal process 60 that results in a slug 62 being separated from the processed product 70. The slug 62 can be continuously or intermittently removed from the processed product 70 and collected on a reel.

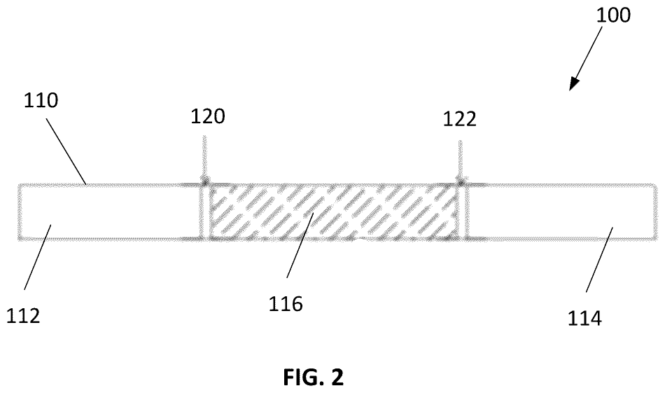

Turning to FIG. 2, an embodiment of a workpiece illustrating an exemplary laser cutting process 100 that relates to process 52 referred in FIG. 1 is illustrated. In this embodiment, the laser cutting process 100 is performed on a laminated workpiece 110. The workpiece 110 can be defined by multiple portions, which in this embodiment are portion 112, portion 114, and portion 116. Portion 116 is a slug that is removed in bulk from portion 112 and 114. In this cutting process 100, a laser is used to remove the slug portion 116 from portions 112 and 114 between cuts 120 and 122.

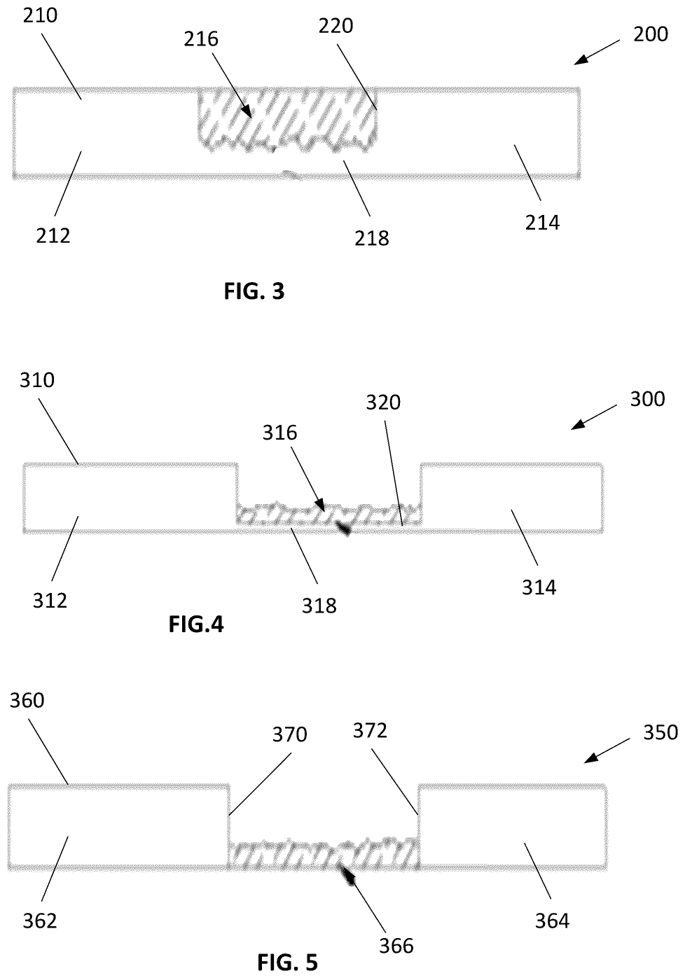

Referring to FIG. 3, an exemplary coarse laser ablation process according to the present invention is illustrated. In this embodiment, the coarse laser ablation process 200 relates to process 54 illustrated in FIG. 1. Process 200 is performed on workpiece 210. Workpiece 200 includes sections or portions 212 and 214 that are spaced apart from each other. Located between portions 212 and 214 are a portion 216 that is removed and a portion 218 that remains between portions 212 and 214. The laser cutting 220 is performed as a blind cut that is depth controlled. The laser cutting 220 is performed on workpiece 210 in a coarse manner that results in portion 216 being removed as a slug and/or as small particles, such as dust. As a result of the cutting 220 of process 200, the remaining portion 218 connects portions 212 and 214. The coarse laser ablation process 200 results in a substantial amount of material being removed as slug 216 from the area between portions 212 and 214.

Next, a fine laser ablation process is performed on the workpiece. Turning to FIG. 4, a fine laser ablation process 300 that relates to process 56 shown in FIG. 1 is illustrated. In particular, the fine laser ablation process 300 is performed as a blind cut. Process 300 is performed on workpiece 310, which is the resulting product of process 200 being performed on workpiece 210 as illustrated in FIG. 3. Workpiece 310 has portions 312 and 314 that correspond to portions 212 and 214. Between sections or portions 312 and 314 are portions 316 and 318, which collectively correspond to remaining portion 218 illustrated in FIG. 3.

In process 300, a fine laser ablation process is performed using a blind cut. Portion 316 is removed as a slug and/or as small particles or dust as a result of cut 320. Portion 318 remains after the cut 320, and connects portions 312 and 314 together.

Turning to FIG. 5, an alternative process to the fine laser ablation process 300 shown in FIG. 4 is illustrated. In this process, a fine laser ablation process 350 can be performed that results in a through cut of the workpiece. The fine laser ablation through cut process 350 can also occur at process 56 shown in FIG. 1. In this embodiment, workpiece 360 has portions 362 and 364, which correspond to portions 212 and 214 of workpiece 210 resulting from the process 200 in FIG. 3. In this process 350, portion 366 between sections or portions 362 and 364 is removed entirely as a slug and/or as small particles, such as dust. Laser cuts 370 and 372 are made to remove portion 366 and the ablation device is used to remove the material from between the cuts 370 and 372.

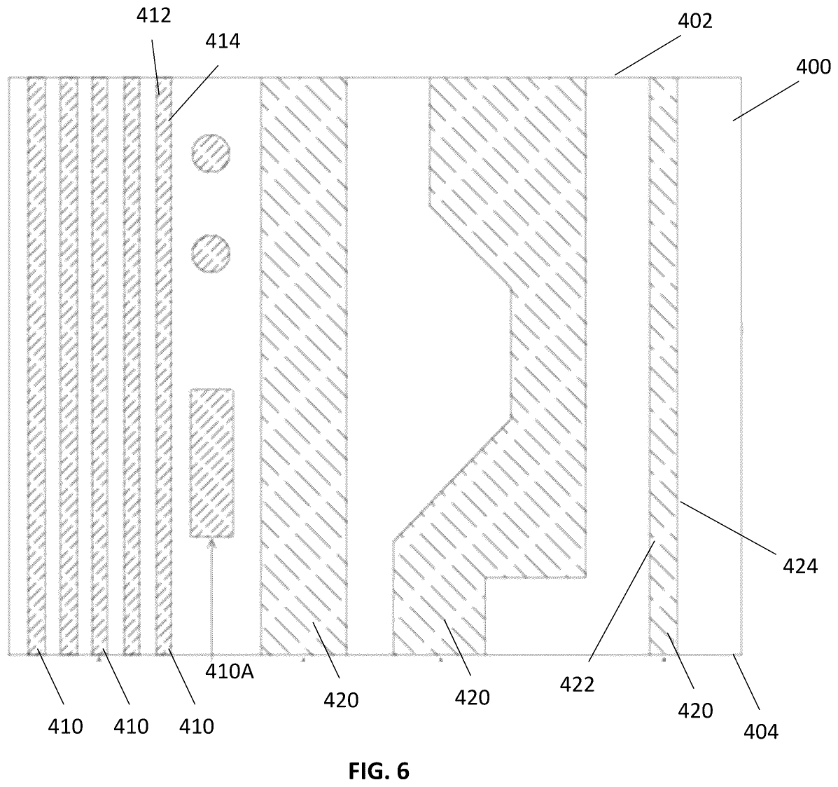

Referring to FIG. 6, an embodiment of a workpiece that shows different cuts that can be made by the above-described processes 100, 200, 300, and 350. The workpiece 400 has opposite ends 402 and 404. Narrow slugs or traces 410 and 410A are made in the workpiece 400 by making cuts 412 and 414 and the removal of the material therebetween. Some of the slugs 410 extend from end 402 to end 404. Alternatively, the workpiece 400 may have one or more isolated small slugs 410A that do not extend between the ends 402 and 404. The narrow slugs or traces 410 and 410A can be removed or processed using process 200 in FIG. 3 and/or processes 300 (see FIG. 4) or 350 (see FIG. 5). It is to be understood that depending on the width of slugs 410 and 410A, processing of the slugs 410 and 410A using the coarse process 100 of FIG. 2 may experience difficulties.

Larger slugs 420 are made in the workpiece 400 by making cuts 422 and 424 and the removal of material therebetween. The larger slugs 420 are wider and have a larger width than the narrow slugs 410 and 410A. In addition, slug 420 in FIG. 6 is exemplary of a variable width slug because the sides of the cut relating to slug 420 The patterns for larger slugs 420 can be processed using the laser cutting process 100 illustrated in FIG. 2. Using the laser ablation processes 200, 300, and/or 350 instead of laser cutting process 100 to process larger 420 will take longer and may create excessive small particles and dust.

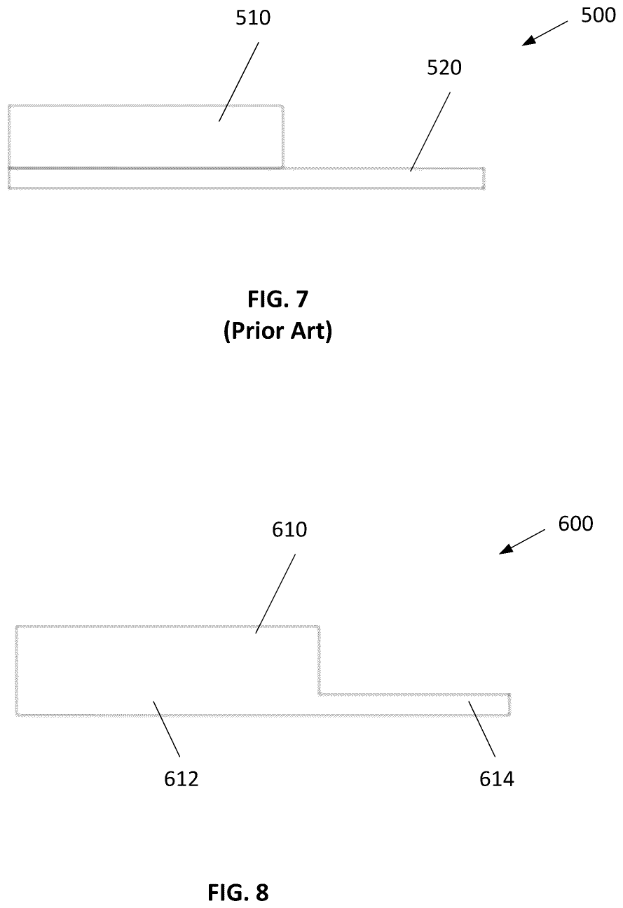

Turning to FIG. 7, the resulting product 500 of a conventional process is illustrated. The conventional process requires two separate layers 510 and 520 to be cut separately and bonded together later.

Turning to FIG. 8, a product 600 formed by one or more of the processes described herein is illustrated. The product 600 is a single layer 610 that has a thicker portion 612 and a thinner portion 614. Fewer processes are required to form product 600 as compared to forming product 500. As a result, there are fewer failure modes in the process or processes to form product 600 as compared to product 500.

While the invention has been illustrated and described in detail and with reference to specific embodiments thereof, it is nevertheless not intended to be limited to the details shown, since it will be apparent that various modifications and structural changes may be made therein without departing from the scope of the inventions and within the scope and range of equivalents of the claims. In addition, various features from one of the embodiments may be incorporated into another of the embodiments. Accordingly, it is appropriate that the appended claims be construed broadly and in a manner consistent with the scope of the disclosure as set forth in the following claims.

Similarly, it is intended that the present invention cover the modifications and variations of this invention that come within the scope of the appended claims and their equivalents. For example, it is to be understood that terms such as “left,” “right,” “top,” “bottom,” “front,” “rear,” “side,” “height,” “length,” “width,” “upper,” “lower,” “interior,” “exterior,” “inner,” “outer” and the like as may be used herein, merely describe points of reference and do not limit the present invention to any particular orientation or configuration. Further, the term “exemplary” is used herein to describe an example or illustration. Any embodiment described herein as exemplary is not to be construed as a preferred or advantageous embodiment, but rather as one example or illustration of a possible embodiment of the invention.

Finally, when used herein, the term “comprises” and its derivations (such as “comprising”, etc.) should not be understood in an excluding sense, that is, these terms should not be interpreted as excluding the possibility that what is described and defined may include further elements, steps, etc. Meanwhile, when used herein, the term “approximately” and terms of its family (such as “approximate,” etc.) should be understood as indicating values very near to those which accompany the aforementioned term. That is to say, a deviation within reasonable limits from an exact value should be accepted, because a skilled person in the art will understand that such a deviation from the values indicated is inevitable due to measurement inaccuracies, etc. The same applies to the terms “about” and “around” and “substantially.”

What is claimed is:

1. A system for processing a workpiece, comprising:
a laminating station at which a first material is laminated to a second material;
a laser cutting device;
a high power ablation device; and
a low power ablation device, wherein the workpiece can be processed by one or more of the laser cutting device, the high power ablation device, or the low power ablation device to remove a slug from the workpiece.

2. The system of claim 1, wherein the slug is a first slug, the first slug is removed from the workpiece using the laser cutting device, and a second slug is removed from the workpiece by the high power ablation device.

3. The system of claim 2, wherein the first slug has a first width, the second slug has second width, and the second width is smaller than the first width.

4. The system of claim 2, wherein the first slug has a variable width.

5. A process for manufacturing a workpiece, comprising the steps of:
laminating a first material to a second material to form a workpiece;
laser cutting part of the workpiece to remove a first portion of the workpiece; and
ablating part of the workpiece to remove a second portion of the workpiece.

6. The process of claim 5, wherein the step of ablating part of the workpiece includes using a coarse ablating process that is a blind cut and depth controlled.

7. The process of claim 5, wherein the step of ablating part of the workpiece includes using a fine ablating process.

8. The process of claim 5, wherein the fine ablating process is a through cut.

9. The process of claim 5, further comprising the step of:
ablating part of the workpiece to remove a third portion of the workpiece at a second power level, wherein the step of ablating part of the workpiece to remove a second portion of the workpiece is at a first power level that is higher than the second power level.

10. A process for manufacturing a workpiece, comprising the steps of:
laminating a first material to a second material to form a workpiece;
laser cutting a first part of the workpiece to remove a first portion of the workpiece from between a first section of the workpiece and a second section of the workpiece; and
ablating a second part of the workpiece to remove a second portion of the workpiece from between the first section of the workpiece and the second section of the workpiece, wherein the laser cutting is at a first power level and the ablating is at a second power level, and the second power lever is different from the first power level.

11. The process of claim 10, wherein the step of ablating part of the workpiece includes using a coarse ablating process that is a blind cut and depth controlled.

12. The process of claim 10, wherein the step of ablating part of the workpiece includes using a fine ablating process.

13. The process of claim 10, wherein the fine ablating process is a through cut.

14. The process of claim 10, further comprising the step of:
ablating a third part of the workpiece to remove a third portion of the workpiece from between the first section of the workpiece and the second section of the workpiece, wherein the step of ablating a third part of the workpiece is at a third power level that is different from the first power level and the second power level.
